(19) United States
(12) Patent Application Publication
(10) Pub. No.: US 2014/0198060 A1
(43) Pub. Date: Jul. 17, 2014

(54) TOUCH DISPLAY APPARATUS

(71) Applicant: HANNSTAR DISPLAY CORPORATION, New Taipei City (TW)

(72) Inventors: Hsu-Ho Wu, Tainan City (TW); Chia-Hua Yu, New Taipei City (TW); Hsuan-Chen Liu, Kaohsiung City (TW); Yi-Chung Juan, Tainan City (TW); Chang-Ching Yeh, Kaohsiung City (TW)

(73) Assignee: HANNSTAR DISPLAY CORPORATION, New Taipei City (TW)

(21) Appl. No.: 13/776,739

(22) Filed: Feb. 26, 2013

(30) Foreign Application Priority Data
Jan. 11, 2013 (CN) 201310011766.5

(51) Int. Cl. G06F 3/041

(52) U.S. Cl. CPC G06F 3/0412
USPC 345/173

(57) ABSTRACT

A touch display apparatus including a display panel, a touch panel, a transparent conductive layer, and a conductive adhesive layer is provided. The touch panel is disposed on the display panel, and includes a cover lens, a touch device, and a shielding conductive ring. The touch device is disposed on the cover lens and located between the display panel and the cover lens. The shielding conductive ring is disposed on the cover lens and located between the display panel and the cover lens. The shielding conductive ring surrounds the touch device. The transparent conductive layer is disposed on the display panel and located between the display panel and the touch panel. The conductive adhesive layer is disposed between the display panel and the touch panel. The shielding conductive ring is electrically connected with the transparent conductive layer through the conductive adhesive layer.

### CROSS-REFERENCE TO RELATED APPLICATION

This application claims the priority benefit of China application serial no. 201310011766.5, filed on Jan. 11, 2013. The entirety of the above-mentioned patent application is hereby incorporated by reference herein and made a part of this specification.

### BACKGROUND OF THE INVENTION

1. Field of the Invention

The invention relates to a touch display apparatus, and particularly relates to a touch display apparatus having a shielding effect.

2. Description of Related Art

With increasing progress towards display technologies, displays facilitate our daily lives, and the demands for light and compact displays contribute to development of flat panel displays (FPDs) as mainstream displays. Recently, all type of electronic products are developed toward easy operation, small volume, and large screen, and the demands of the volume and the screen size in the portable products are particularly stringent. Therefore, many electronic products combine a touch design into a display panel so as to omit the space for disposing the keyboard or the operation button and enlarge the disposition area of the screen.

Generally speaking, a touch display panel includes a display panel and a touch panel, wherein the touch panel may be built in the display panel or externally pasted onto the display panel. Based on different sensing types, a touch panel can be generally categorized into a resistance touch panel, a capacitive touch panel, an optical touch panel, an acoustic-wave touch panel and an electromagnetic touch panel. Furthermore, due to modularization, a driving circuit of the display panel and a driving circuit of the touch panel are usually designed separately, such that the driving circuit of the display panel and the driving circuit of the touch panel operate separately.

Since the touch panel is built in the display panel or externally pasted onto the display panel, a sensing signal output by the display panel is easily influenced by an electric field of the display panel, therefore affecting a touch quality (e.g. sensitivity and accuracy) of the touch panel. Currently, one way to improve the touch quality of the touch panel is to add a shielding electrode layer having a metallic ground ring on the touch panel, such that an interference of the display panel on the touch panel is suppressed, thereby reducing an interference of the electric field of the display panel on the touch panel. However, the shielding electrode layer having the metallic ground ring is more costly, and needs to be additionally purchased to be adhered on the touch panel. Although the above-described solution reduces the interference of the display panel on the touch panel, it makes the cost of the touch display apparatus higher.

### SUMMARY OF THE INVENTION

The invention provides a touch apparatus having a lower manufacture cost.

The touch display apparatus of the invention includes a display panel, a touch panel, a transparent conductive layer, and a conductive adhesive layer. The touch panel is disposed on the display panel, and includes a cover lens, a touch device, and a shielding conductive ring. The touch device is disposed on the cover lens and located between the display panel and the cover lens. The shielding conductive ring is disposed on the cover lens and located between the display panel and the cover lens, wherein the shielding conductive ring surrounds the touch device. The transparent conductive layer is disposed on the display panel and located between the display panel and the touch panel. The conductive adhesive layer is disposed between the display panel and the touch panel, wherein the shielding conductive ring is electrically connected with the transparent conductive layer through the conductive adhesive layer.

In an embodiment of the invention, the touch display apparatus further includes an apparatus housing, wherein the display panel is disposed in the apparatus housing, and the apparatus housing extends to be disposed on the transparent conductive layer and expose a portion of the transparent conductive layer.

In an embodiment of the invention, a material of the apparatus housing is a conductive material, the conductive adhesive layer is located between the shielding conductive ring and the apparatus housing, and the shielding conductive ring is electrically connected with the transparent conductive layer through the conductive adhesive layer and the apparatus housing.

In an embodiment of the invention, a material of the apparatus housing is a dielectric material, and the conductive adhesive layer is located between the shielding conductive ring and the transparent conductive layer and directly contacts the transparent conductive layer.

In an embodiment of the invention, the touch display apparatus further includes an adhesive layer surrounding the cover lens and located between the cover lens and the apparatus housing, wherein the touch panel is fixed on the apparatus housing through the adhesive layer.

In an embodiment of the invention, the touch panel has a sensing area and a peripheral area surrounding the sensing area, the touch device includes at least one sensing electrode layer and at least one transmitting line electrically connected with the sensing electrode layer, the sensing electrode layer is located in the sensing area, and the transmitting line is located in the peripheral area.

In an embodiment of the invention, the sensing electrode layer includes a plurality of first sensing series and a plurality of second sensing series, each of the first sensing series extends along a first direction, each of the second sensing series extends along a second direction, and the first direction is different from the second direction.

In an embodiment of the invention, a material of the transmitting line is metal.

In an embodiment of the invention, a material of the shielding conductive ring is metal or a transparent conductive material.

In an embodiment of the invention, the shielding conductive ring is an enclosed circular structure or a non-enclosed circular structure.

In view of the foregoing, the touch display apparatus of the invention is disposed with the shielding conductive ring on the cover lens of the touch panel, and the conductive adhesive layer is used to electrically connect the transparent conductive layer disposed on the display panel and located between the display panel and the touch panel. Therefore, the shielding conductive ring is capable of generating a shielding effect to suppress a parasitic capacitance generated between the transparent conductive layer and the touch device, so as to further prevent the noise interference to the touch signal sensed by the touch device. Moreover, the shielding conductive ring is also capable of preventing electrostatic discharge. Therefore, when there is undesirable electrostatic charge accumulation in the touch panel or the display panel, disposing the shielding conductive ring helps in releasing electrostatic charges. Furthermore, the shielding conductive ring may be integrated into the conventional manufacturing process of the touch display apparatus. Therefore, there is no need to additionally purchase a transparent conductive thin film having a metallic ring, and the manufacture cost is therefore effectively reduced.

To make the aforementioned features and advantages of the invention more comprehensible, several embodiments accompanied with drawings are described in detail as follows.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1A is a cross-sectional schematic view of a touch display apparatus according to an embodiment of the invention.

FIG. 1B is a bottom schematic view of a touch panel of the touch display apparatus of FIG. 1A.

FIG. 2 is a cross-sectional schematic view of a touch display apparatus according to another embodiment of the invention.

FIG. 3 is a cross-sectional schematic view of a touch display apparatus according to still another embodiment of the invention.

### DESCRIPTION OF THE EMBODIMENTS

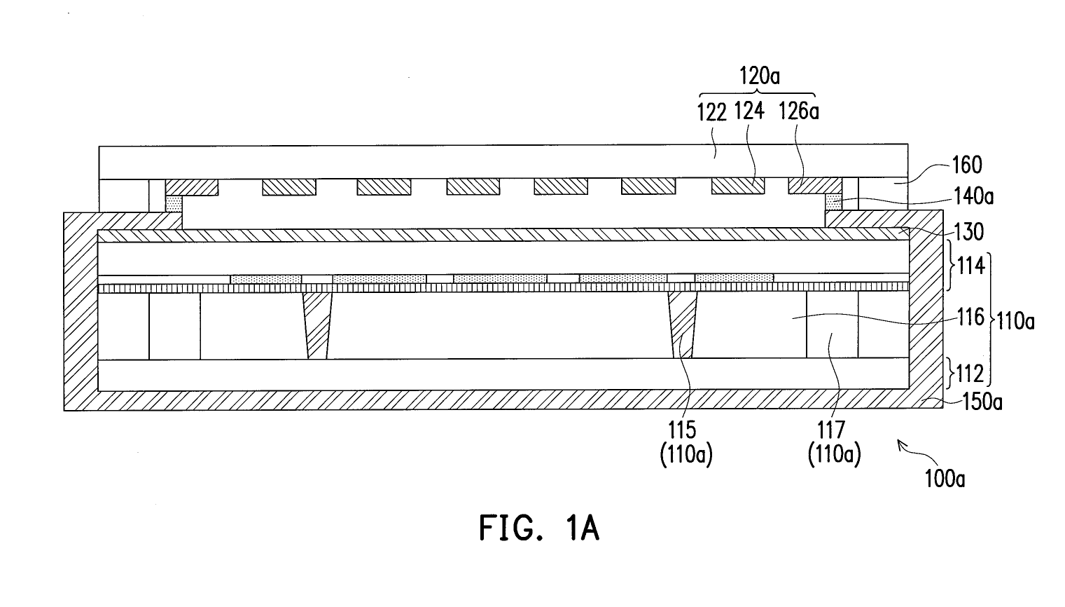

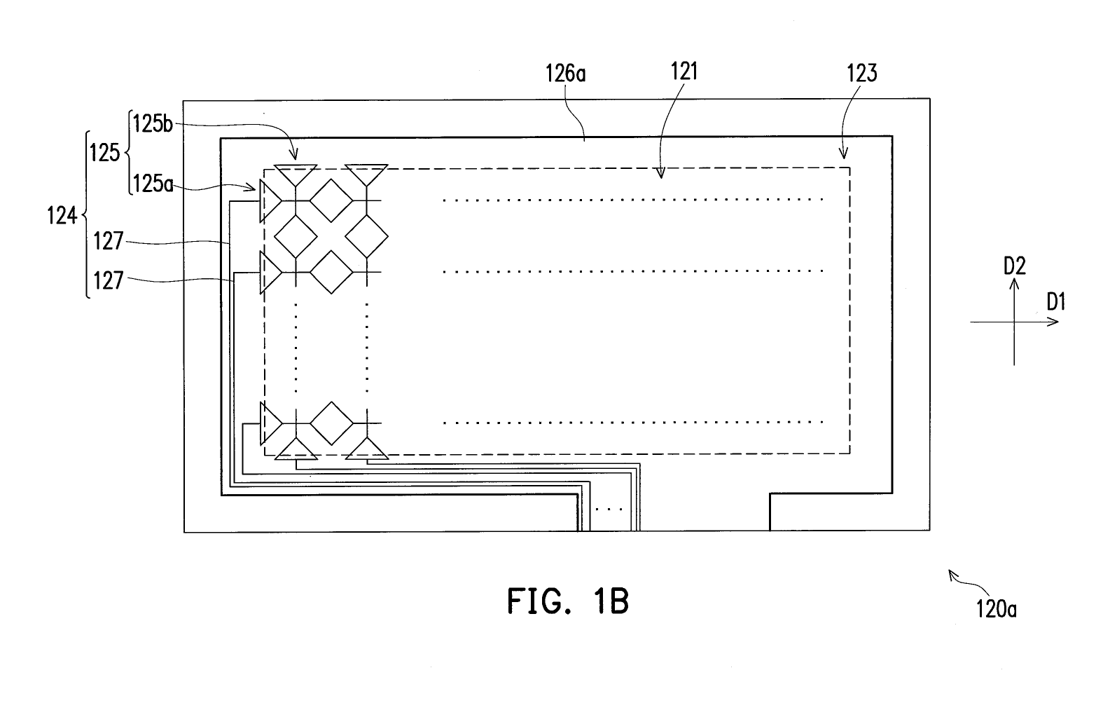

FIG. 1A is a cross-sectional schematic view of a touch display apparatus according to an embodiment of the invention. FIG. 1B is a bottom schematic view of a touch panel of the touch display apparatus of FIG. 1A. Referring to FIGS. 1A and 1B at the same time, in this embodiment, a touch display apparatus 100a includes a display panel 110a, a touch panel 120a, a transparent conductive layer 130, and a conductive adhesive layer 140a. The touch panel 120a is disposed on the display panel 110a, and includes a cover lens 122, a touch device 124, and a shielding conductive ring 126a. The touch device 124 is disposed on the cover lens 122 and is located between the display panel 110a and the cover lens 122. The shielding conductive ring 126a is disposed on the cover lens 122 and located between the display panel 110a and the cover lens 122, wherein the shielding conductive ring 126a surrounds the touch device 124. The transparent conductive layer 130 is disposed on the display panel 110a and located between the display panel 110a and the touch panel 120a. The conductive adhesive layer 140a is disposed between the display panel 110a and the touch panel 120a, wherein the shielding conductive ring 126a is electrically connected with the transparent conductive layer 130 through the conductive adhesive layer 140a.

More specifically, in this embodiment, the display panel 110a is a twist nematic (TN) display panel, for example, wherein the display panel 110a includes an active device array substrate 112, a color filter substrate 114, a display medium 116, a plurality of spacers 115, and a sealant 117. The display medium 116 is located between the active device array substrate 112 and the color filter substrate 114, wherein the display medium 116 is a liquid crystal material, for example, but the disclosure is not limited thereto. The spacers 115 are located between the active device array substrate 112 and the color filter substrate 114, such that a space is kept between the active device array substrate 112 and the color filter substrate 114. The sealant 117 is disposed between the active device array substrate 112 and the color filter substrate 114 and surrounds the active device array substrate 112 and the color filter substrate 114, such that the display medium 116 is sealed between the active device array substrate 112 and the color filter substrate 114. The transparent conductive layer 130 is a layer in a single-layer structure and directly disposed on the color filter substrate 114, wherein a material of the transparent conductive layer 130 is an Indium Tin Oxide (ITO), for example.

Referring to FIG. 1B again, the touch panel 120a has a sensing area 121 and a peripheral area 123 surrounding the sensing area 121. The touch device 124 includes at least one sensing electrode layer 125 and at least one transmitting line 127 electrically connected with the sensing electrode layer 125, wherein the sensing electrode layer 125 is located in the sensing area 121, and the transmitting line 127 is located in the peripheral area 123. More specifically, in this embodiment, the sensing electrode layer 125 includes a plurality of first sensing series 125a and a plurality of second sensing series 125b, wherein each of the first sensing series 125a extends along a first direction D1, each of the second sensing series 125b extends along a second direction D2, and the first direction D1 is different from the second direction D2. Although an electrode pad of the first sensing series 125a and the second sensing series 125b illustrated in FIG. 1B is in a diamond shape, the electrode pad may be electrode series formed of a plurality of electrodes in a circle, rectangle, or other polygonal shapes in other embodiments not shown herein. Naturally, the sensing electrode layer 125 may be a plurality of strip electrodes formed in the sensing area 121.

The shielding conductive ring 126a is at a shielding potential, and the shielding conductive ring 126a may be a metal at the same layer with or a different layer from the transmitting line 127 or a transparent conductive material that is at the same layer with or a different layer from the first sensing series 125a and/or the second sensing series 125b.

In particular, in this embodiment, a material of the transmitting line 127 is a metal, for example, and the shielding conductive ring 126a and the transmitting line 127 are at the same layer. Namely, when the transmitting line 127 is manufactured, the shielding conductive ring 126a is formed at the same time, making a material of the shielding conductive ring 126a also a metal. As shown in FIG. 1B, the shielding conductive ring 126a is in a non-enclosed circular structure. Naturally, in other embodiments, the material of the shielding conductive ring 126a may be a transparent conductive material, such as an Indium Tin Oxide (ITO), while the shielding conductive ring 126a may be in an enclosed circular structure.

Furthermore, referring to FIG. 1A again, the touch display apparatus 100a of this embodiment further includes an apparatus housing 150a, wherein the display panel 110a is disposed in the apparatus housing 150a, while the apparatus housing 150a extends to be disposed on the transparent conductive layer 130 and expose a portion of the transparent conductive layer 130. In particular, the conductive adhesive layer 140a directly contacts the apparatus housing 150a. Here, a material of the apparatus housing 150a is a conductive material, the conductive adhesive layer 140a is located between the shielding conductive ring 126a and the apparatus housing 150a, and the shielding conductive ring 126a is electrically connected with the transparent conductive layer 130 through the conductive adhesive layer 140a and the apparatus housing 150a. In this way, when there is undesirable electrostatic charge accumulation in the touch display apparatus 100a, electrostatic charges may be transmitted to the apparatus housing 150a through the shielding conductive ring 126a and the conductive adhesive layer 140a and released. Therefore, electrostatic charges are hardly accumulated in the touch display apparatus 100a, and electrostatic discharge may be prevented to reduce a chance of device damage and elongate a lifespan. In addition, the touch display apparatus 100a may further include an adhesive layer 160, wherein the adhesive layer 160 surrounds the cover lens 122 and is located between the cover lens 122 and the apparatus housing 150a. The touch panel 120a is fixed on the apparatus housing 150a through the adhesive layer 160. Here, the adhesive layer 160 is a rectangular shape.

The shielding conductive ring 126a is disposed on the cover lens 122 of the touch panel 120a in the touch display apparatus 100a of this embodiment, and the shielding conductive ring 126a is electrically connected with the transparent conductive layer 130 disposed on the display panel 110 through the conductive adhesive layer 140a and the apparatus housing 150a. Therefore, the shielding conductive ring 126a is capable of generating a shielding effect to suppress a parasitic capacitance generated between the transparent conductive layer 130 and the touch device 124, so as to further prevent noise interference to a touch signal sensed by the touch device 124. Moreover, the shielding conductive ring 126a is also capable of preventing electrostatic discharge. Therefore, when there is undesirable electrostatic charge accumulation in the touch panel 120a or the display panel 110a, disposing the shielding conductive ring 126a helps in releasing electrostatic charges. Furthermore, the shielding conductive ring 126a may be integrated into a conventional manufacturing process of the touch display apparatus 100a. Therefore, there is no need to additionally purchase a transparent conductive thin film having a metallic ring, and a manufacture cost is therefore effectively reduced.

It should be noted that the reference numerals and a part of the contents in the previous embodiment are used in the following embodiments, in which identical reference numerals indicate identical or similar components, and repeated description of the same technical contents is omitted. For a detailed description of the omitted parts, reference can be found in the previous embodiment, and no repeated description is contained in the following embodiments.

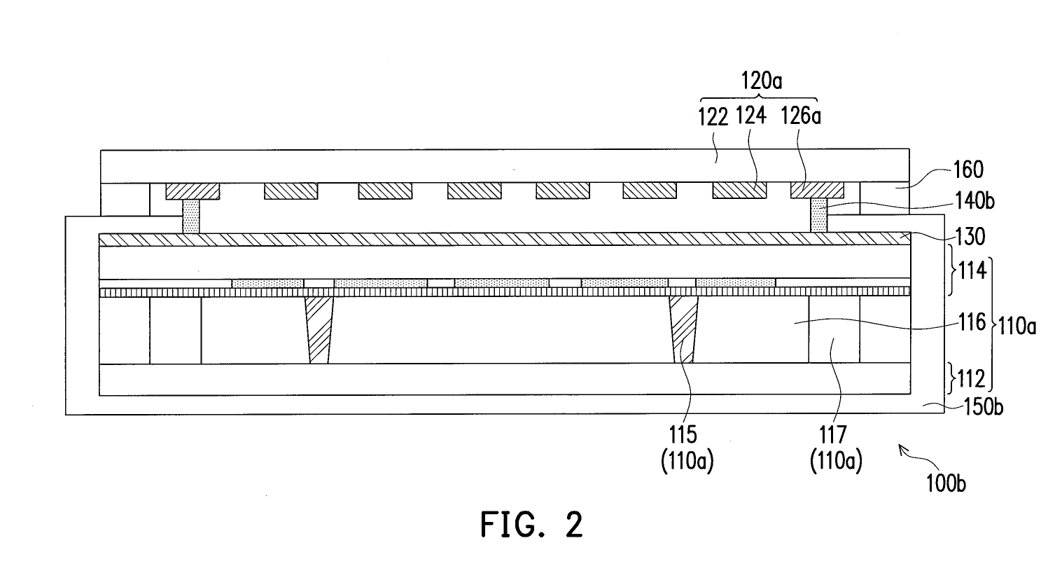

FIG. 2 is a cross-sectional schematic view illustrating a touch display apparatus according to another embodiment of the invention. Referring to FIG. 2, a touch display apparatus 100b of this embodiment is similar to the touch display apparatus 100a of FIG. 1A, while the main difference therebetween lies in that a material of an apparatus housing 150b is a dielectric material. Namely, the apparatus housing 150b is not conductive. A conductive adhesive layer 140b is located between the shielding conductive ring 126a and the transparent conductive payer 130, and one side of the conductive adhesive layer 140b directly contacts the apparatus housing 150b.

The shielding conductive ring 126a is disposed on the cover lens 122 of the touch panel 120a in the touch display apparatus 100b of this embodiment, and the shielding conductive ring 126a is electrically connected with the transparent conductive layer 130 disposed on the display panel 110 directly through the conductive adhesive layer 140b. Therefore, the shielding conductive ring 126a is capable of generating a shielding effect to suppress a parasitic capacitance generated between the transparent conductive layer 130 and the touch device 124, so as to further prevent a noise interference to a touch signal sensed by the touch device 124. Moreover, the shielding conductive ring 126a is also capable of preventing electrostatic discharge. Therefore, when there is undesirable electrostatic charge accumulation in the touch panel 120a or the display panel 110a, disposing the shielding conductive ring 126a helps in releasing electrostatic charges. Furthermore, the shielding conductive ring 126a may be integrated into a conventional manufacturing process of the touch display apparatus 100b. Therefore, there is no need to additionally purchase a transparent conductive thin film having a metallic ring, and a manufacture cost is therefore effectively reduced.

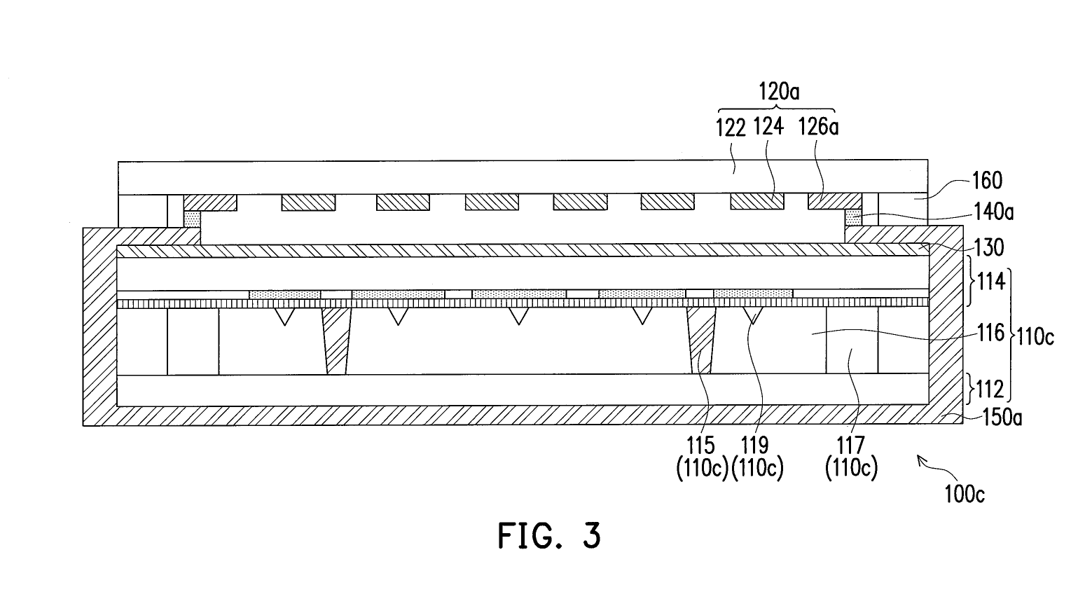

FIG. 3 is a cross-sectional schematic view illustrating a touch display apparatus according to still another embodiment of the invention. Referring to FIG. 3, a touch display apparatus 100c of this embodiment is similar to the touch display apparatus 100a of FIG. 1A, while the main difference therebetween lies in that a display panel 110c of the touch display apparatus 100c of this embodiment is a vertical alignment (VA) display panel, wherein the display panel 110c includes the active device array substrate 112, the color filter substrate 114, the display medium 116, the plurality of spacers 115, the sealant 117, and a plurality of alignment protrusions 119. The alignment protrusions 119 are disposed on the color filter substrate 114 and is located between the active device array substrate 112 and the color filter substrate 114, wherein the alignment protrusions 119 may be used with a main slit (not shown) of a pixel electrode on the active device array substrate 112 to achieve a multi-domain vertical alignment.

In other words, the disclosure does not impose a limitation on a configuration of the display panels 110a and 110c. Even though the display panels 110a and 110c described herein are respectively a twist nematic display panel and a vertical alignment display panel, in other embodiment not shown herein, the display panel may be an organic electroluminescent display (OELD) panel or other appropriate display panel. The disclosure is not limited thereto.

In view of the foregoing, the touch display apparatus of the invention is disposed with the shielding conductive ring on the cover lens of the touch panel, and the conductive adhesive layer is used to electrically connect the transparent conductive layer disposed on the display panel and located between the display panel and the touch panel. Therefore, the shielding conductive ring is capable of generating a shielding effect to suppress a parasitic capacitance generated between the transparent conductive layer and the touch device, so as to further prevent the noise interference to the touch signal sensed by the touch device. Moreover, the shielding conductive ring is also capable of preventing electrostatic discharge. Therefore, when there is undesirable electrostatic charge accumulation in the touch panel or the display panel, disposing the shielding conductive ring helps in releasing electrostatic charges. Furthermore, the shielding conductive ring may be integrated into the conventional manufacturing process of the touch display apparatus. Therefore, there is no need to additionally purchase a transparent conductive thin film having a metallic ring, and the manufacture cost is therefore effectively reduced.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A touch display apparatus, comprising:
a display panel;
a touch panel disposed on the display panel, comprising:
a cover lens;
a touch device disposed on the cover lens and located between the display panel and the cover lens; and
a shielding conductive ring disposed on the cover lens and located between the display panel and the cover lens, wherein the shielding conductive ring surrounds the touch device;
a transparent conductive layer disposed on the display panel and located between the display panel and the touch panel; and
a conductive adhesive layer disposed between the display panel and the touch panel, wherein the shielding conductive ring is electrically connected with the transparent conductive layer through the conductive adhesive layer.

2. The touch display apparatus as claimed in claim 1, further comprising an apparatus housing, wherein the display panel is disposed in the apparatus housing, and the apparatus housing extends to be disposed on the transparent conductive layer and expose a portion of the transparent conductive layer.

3. The touch display apparatus as claimed in claim 2, wherein a material of the apparatus housing is a conductive material, the conductive adhesive layer is located between the shielding conductive ring and the apparatus housing, and the shielding conductive ring is electrically connected with the transparent conductive layer through the conductive adhesive layer and the apparatus housing.

4. The touch display apparatus as claimed in claim 2, wherein a material of the apparatus housing is a dielectric material, and the conductive adhesive layer is located between the shielding conductive ring and the transparent conductive layer and directly contacts the transparent conductive layer.

5. The touch display apparatus as claimed in claim 2, further comprising an adhesive layer surrounding the cover lens and located between the cover lens and the apparatus housing, wherein the touch panel is fixed on the apparatus housing through the adhesive layer.

6. The touch display apparatus as claimed in claim 1, wherein the touch panel has a sensing area and a peripheral area surrounding the sensing area, the touch device comprises at least one sensing electrode layer and at least one transmitting line electrically connected with the sensing electrode layer, the sensing electrode layer is located in the sensing area, and the transmitting line is located in the peripheral area.

7. The touch display apparatus as claimed in claim 6, wherein the sensing electrode layer comprises a plurality of first sensing series and a plurality of second sensing series, each of the first sensing series extends along a first direction, each of the second sensing series extends along a second direction, and the first direction is different from the second direction.

8. The touch display apparatus as claimed in claim 6, wherein a material of the transmitting line is metal.

9. The touch display apparatus as claimed in claim 1, wherein a material of the shielding conductive ring is metal or a transparent conductive material.

10. The touch display apparatus as claimed in claim 1, wherein the shielding conductive ring is an enclosed circular structure or a non-enclosed circular structure.
